(19) United States
(12) Patent Application Publication
(10) Pub. No.: US 2026/0058376 A1
(43) Pub. Date: Feb. 26, 2026

(54) ANTENNA AND COMMUNICATION DEVICE

(71) Applicant: HUAWEI TECHNOLOGIES CO., LTD., Shenzhen (CN)

(72) Inventors: Min Yu, Chengdu (CN); Qian Zhang, Shenzhen (CN); Xin Luo, Chengdu (CN)

(73) Assignee: HUAWEI TECHNOLOGIES CO., LTD., Shenzhen (CN)

(21) Appl. No.: 19/355,697

(22) Filed: Oct. 10, 2025

Related U.S. Application Data
(63) Continuation of application No. PCT/CN2023/142899, filed on Dec. 28, 2023.

(30) Foreign Application Priority Data
Apr. 13, 2023 (CN) 202310444405.3

(51) Int. Cl. H01Q 21/26; H01Q 9/28; H01Q 9/30; H01Q 21/06

(52) U.S. Cl. CPC H01Q 21/26; H01Q 9/285; H01Q 9/30; H01Q 21/061

(57) ABSTRACT

An antenna and a communication device are disclosed, and relate to the field of communication device technologies. The antenna includes a ground plane and at least one group of antenna elements disposed on the ground plane. One group of antenna elements include two dipole radiation arms and two monopole radiation arms. A feed point is provided on the dipole radiation arms and/or the monopole radiation arms. The dipole radiation arms are provided with a support structure. For a same group of antenna elements, both the two dipole radiation arms are disposed in parallel to the ground plane via the support structure; both the two monopole radiation arms are vertically disposed on the ground plane; and both the two dipole radiation arms are located between the two monopole radiation arms, and the two dipole radiation arms and the two monopole radiation arms are in a same plane.

### CROSS-REFERENCE TO RELATED APPLICATIONS

This application is a continuation of International Application No. PCT/CN2023/142899 filed on Dec. 28, 2023, which claims priority to Chinese Patent Application No. 202310444405.3 filed on Apr. 13, 2023. The disclosures of the aforementioned applications are hereby incorporated by reference in their entireties.

### TECHNICAL FIELD

This application relates to the field of communication device technologies, and in particular, to an antenna and a communication device.

### BACKGROUND

Wireless fidelity (Wi-Fi) signal coverage is provided by access point (AP) devices. Research has shown that a channel capacity can be significantly increased by using polarization diversity of electromagnetic waves. Therefore, for an AP device, a dual-polarized omnidirectional antenna needs to generate a horizontal polarization omnidirectional beam and a vertical polarization omnidirectional beam of a same beam shape. A conventional dual-polarized omnidirectional antenna usually includes a horizontal loop antenna configured to generate a horizontal polarization omnidirectional beam and a radiation arm configured to generate a vertical polarization omnidirectional beam. However, large space is needed for deployment of the horizontal loop antenna. This is not conducive to miniaturization of the dual-polarized omnidirectional antenna.

### SUMMARY

This application provides an antenna and a communication device, to reduce a size of a dual-polarized omnidirectional antenna, so as to miniaturize the dual-polarized omnidirectional antenna.

To achieve the foregoing objective, the following technical solutions are used in this application.

According to a first aspect, an antenna is provided, including a ground plane and at least one group of antenna elements disposed on the ground plane. One group of antenna elements includes two dipole radiation arms and two monopole radiation arms. A feed point is provided on the dipole radiation arms and/or the monopole radiation arms. The dipole radiation arms are provided with a support structure. For a same group of antenna elements, both the two dipole radiation arms are disposed in parallel to the ground plane via the support structure; both the two monopole radiation arms are vertically disposed on the ground plane; and both the two dipole radiation arms are located between the two monopole radiation arms, and the two dipole radiation arms and the two monopole radiation arms are in a same plane.

In an embodiment, the two dipole radiation arms and the two monopole radiation arms in the same group are disposed in the same plane, so that planarization of a dual-polarized omnidirectional antenna is implemented. In comparison with a conventional horizontal loop antenna, in this application, space can be saved for arranging another component, so that a size of the dual-polarized omnidirectional antenna is reduced, and this helps miniaturize the dual-polarized omnidirectional antenna.

In an embodiment, a length of the dipole radiation arm is one eighth of a guided-wave wavelength to three eighths of the guided-wave wavelength, and the guided-wave wavelength is a wavelength of an electromagnetic wave received or transmitted by the antenna element in an operating frequency band. When an alternating current flows on the dipole radiation arm, electromagnetic wave radiation may occur. When the length of the dipole radiation arm is one eighth of the guided-wave wavelength to three eighths of the guided-wave wavelength, the dipole radiation arm can have good radiation effects.

In an embodiment, the length of the dipole radiation arm is one quarter of the guided-wave wavelength. In this case, the dipole radiation arm can generate a resonance with the electromagnetic wave, so that the dipole radiation arm converts the current into an electromagnetic wave or converts the received electromagnetic wave into a current with high efficiency.

In an embodiment, a length of the monopole radiation arm is one eighth of the guided-wave wavelength to three eighths of the guided-wave wavelength. When an alternating current flows on the monopole radiation arm, electromagnetic wave radiation may occur. When the length of the monopole radiation arm is one eighth of the guided-wave wavelength to three eighths of the guided-wave wavelength, the monopole radiation arm can have good radiation effects.

In an embodiment, the length of the monopole radiation arm is one quarter of the guided-wave wavelength. In this case, the monopole radiation arm can generate a resonance with the electromagnetic wave, so that the monopole radiation arm converts the current into an electromagnetic wave or converts the received electromagnetic wave into a current with high efficiency.

In an embodiment, distances between the two dipole radiation arms and the ground plane are one eighth of the guided-wave wavelength to three eighths of the guided-wave wavelength. Electromagnetic waves on the dipole radiation arms are superposed through mirror reflection on the ground plane. When the distances between the two dipole radiation arms and the ground plane are one eighth of the guided-wave wavelength to three eighths of the guided-wave wavelength, superposition efficiency is good.

In an embodiment, both the distances between the two dipole radiation arms and the ground plane are one quarter of the guided-wave wavelength. In this case, a reflected wave and an emergent wave at the dipole radiation arm are just in phase, and electromagnetic wave superposition efficiency is the highest.

In an embodiment, a distance between the two monopole radiation arms is one quarter of the guided-wave wavelength to three quarters of the guided-wave wavelength. When the distance between the two monopole radiation arms is one quarter of the guided-wave wavelength to three quarters of the guided-wave wavelength, electromagnetic waves on the two monopole radiation arms have good superposition efficiency.

In an embodiment, the distance between the two monopole radiation arms is a half of the guided-wave wavelength. In this case, the electromagnetic waves at the two monopole radiation arms are just in phase, and electromagnetic wave superposition efficiency is the highest.

In an embodiment, the feed point includes: a first feed point, provided at a coupling point between the two dipole radiation arms, where the dipole radiation arms are directly excited through the first feed point.

In an embodiment, the two monopole radiation arms are a first monopole radiation arm and a second monopole radiation arm respectively, and the feed point includes: a second feed point, provided at a coupling point between the first monopole radiation arm and the ground plane; and a third feed point, provided at a coupling point between the second monopole radiation arm and the ground plane, where the first monopole radiation arm is directly excited through the second feed point, and the second monopole radiation arm is directly excited through the third feed point.

In an embodiment, the antenna element is made of a metal mechanical part, a printed circuit board, or plastic with a metal coating.

In an embodiment, for a same group of antenna elements, the support structure, the two dipole radiation arms, and the two monopole radiation arms are integrally formed by stamping a metal plate. A metal plate stamping process is used, so that the antenna is easy to produce and assemble, and a loss of pure metal is low.

In an embodiment, two groups of antenna elements are disposed, planes in which the two groups of antenna elements are located intersect, and the two groups of antenna elements share the ground plane. Electromagnetic waves transmitted/received by the two groups of antenna elements are superposed, to improve an antenna gain.

In an embodiment, the antenna further includes a dielectric layer, where the dielectric layer is disposed on a side of the antenna element away from the ground plane. The dielectric layer causes a pattern of the dipole radiation arm to expand to two sides, so that roundness of a combined overall pattern is better, and the pattern has no null in a normal direction.

According to a second aspect, this application provides a communication device, including a feeder, a feeding network, and the antenna according to the first aspect, where the feeding network is connected to the feed point of the antenna through the feeder.

For technical effects of the second aspect, refer to technical effects of any one of the first aspect and the embodiments of the first aspect. Details are not described herein.

### BRIEF DESCRIPTION OF DRAWINGS

FIG. 1 is a diagram of a typical signal coverage area of an AP device according to this application;

FIG. 2 is a pattern of a typical omnidirectional beam of an antenna of an AP device according to this application;

FIG. 3 is a diagram of a polarization requirement of an omnidirectional beam of an antenna of an AP device according to this application;

FIG. 4 is a diagram of a structure of a conventional horizontal loop antenna in the background of this application;

FIG. 5 is a diagram of a structure of a conventional radiation arm in the background of this application;

FIG. 6 is a diagram of a structure of a communication device according to an embodiment of this application;

FIG. 7 is a diagram of an overall structure of an antenna according to an embodiment of this application;

FIG. 8 is a diagram of a structure of a basic principle of an antenna according to an embodiment of this application;

FIG. 9 shows a pattern of a dipole radiation arm, a pattern of a monopole radiation arm, and a combined overall pattern according to an embodiment of this application;

FIG. 10 is a beam pattern of an antenna according to an embodiment of this application;

FIG. 11 is a diagram of another overall structure of an antenna according to an embodiment of this application;

FIG. 12 is a diagram of an overall structure of a combination of intersected two sets of antenna elements according to an embodiment of this application; and

FIG. 13 is a diagram of an overall structure of deployment of a plurality of sets of antenna elements according to an embodiment of this application.

Reference numerals: 1: ground plane; 2: antenna element; 21: dipole radiation arm; 211: first dipole radiation arm; 212: second dipole radiation arm; 22: monopole radiation arm; 221: first monopole radiation arm; 222: second monopole radiation arm; 3: support structure; 4: feed point; 41: first feed point; 42: second feed point; 43: third feed point; 5: dielectric layer; 6: feeder; 7: feeding network; and 8: antenna.

### DESCRIPTION OF EMBODIMENTS

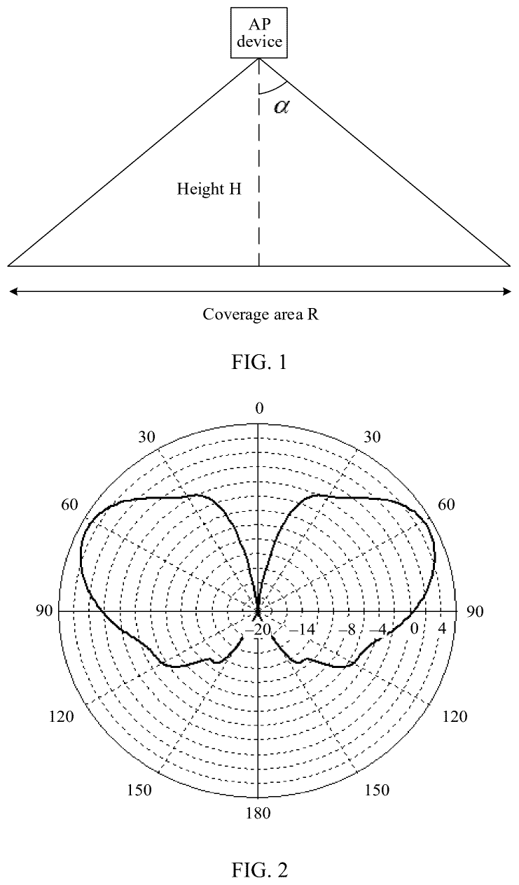

To make objectives, technical solutions, and advantages of this application clearer and more comprehensible, the following further describes this application in detail with reference to FIG. 1 to FIG. 13 and embodiments. It should be understood that the specific embodiments described herein are merely used to explain this application but are not intended to limit this application.

The terms “first”, “second”, and the like in embodiments of this application are merely used to distinguish between features of a same type, and cannot be understood as indicating relative importance, a quantity, a sequence, or the like.

The term “example”, “for example”, or the like in embodiments of this application is used to represent giving an example, an illustration, or a description. Any embodiment or design scheme described as an “example” or “for example” in this application should not be explained as being more preferred or having more advantages than another embodiment or design scheme. To be precise, use of the term “example”, “for example”, or the like is intended to present a relative concept in a specific manner.

The terms “coupling” and “connection” in embodiments of this application should be understood in a broad sense. For example, the connection may be a physical direct connection, or may be an indirect connection implemented via an electronic component, for example, a connection implemented via a resistor, an inductor, a capacitor, or another electronic component.

FIG. 1 shows a typical signal coverage area of an AP device. Ceiling-mounted AP devices can implement Wi-Fi signal coverage in large areas such as offices, shopping malls, stadiums, and campuses. A signal coverage area R of each AP device is determined based on a height H and an antenna beam angle α of the AP device. To implement even coverage of Wi-Fi signals, as shown in FIG. 2, an antenna pattern (where the pattern is a graphic representation of a directivity function, and is for describing a relationship in which antenna radiation intensity, field strength, a phase, and polarization change with spatial direction coordinates) on a vertical tangent plane needs to be expanded to two sides to form a large antenna beam angle. In addition, on a horizontal tangent plane, the antenna pattern is circular. Therefore, an omnidirectional antenna (where the omnidirectional antenna is represented as 360°even radiation in a horizontal pattern and is represented as a beam with a specific width in a vertical pattern) is generally used in the AP device to meet the foregoing requirements.

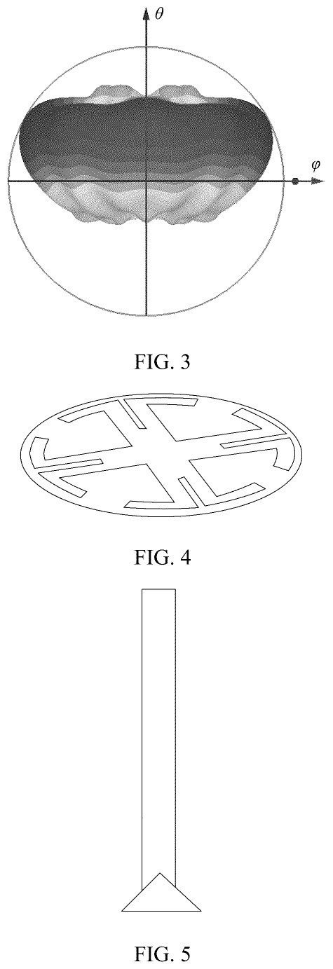

In addition, to improve a channel capacity, the AP device needs to perform radiation via two types of antennas to generate a vertical polarization omnidirectional beam and a horizontal polarization omnidirectional beam of a same beam shape, to implement polarization diversity of electromagnetic waves, and satisfy an omnidirectional beam polarization requirement shown in FIG. 3, where θ represents vertical polarization, and φ represents horizontal polarization. To be specific, for the antenna in the AP device, a dual-polarized omnidirectional antenna mainly includes two types of antennas: a horizontal loop antenna shown in FIG. 4 and a radiation arm shown in FIG. 5. The horizontal loop antenna is configured to generate a horizontal polarization omnidirectional beam, and the radiation arm is configured to generate a vertical polarization omnidirectional beam. However, large space is needed for deployment of the horizontal loop antenna. This is not conducive to miniaturization of the dual-polarized omnidirectional antenna.

In embodiments of this application, two dipole radiation arms and two monopole radiation arms in a same group of antenna elements are disposed in a same plane, so that planarization of an antenna is implemented. In comparison with a conventional horizontal loop antenna, in this application, space can be saved for arranging another component, so that a size of the dual-polarized omnidirectional antenna is reduced, and this helps miniaturize the dual-polarized omnidirectional antenna.

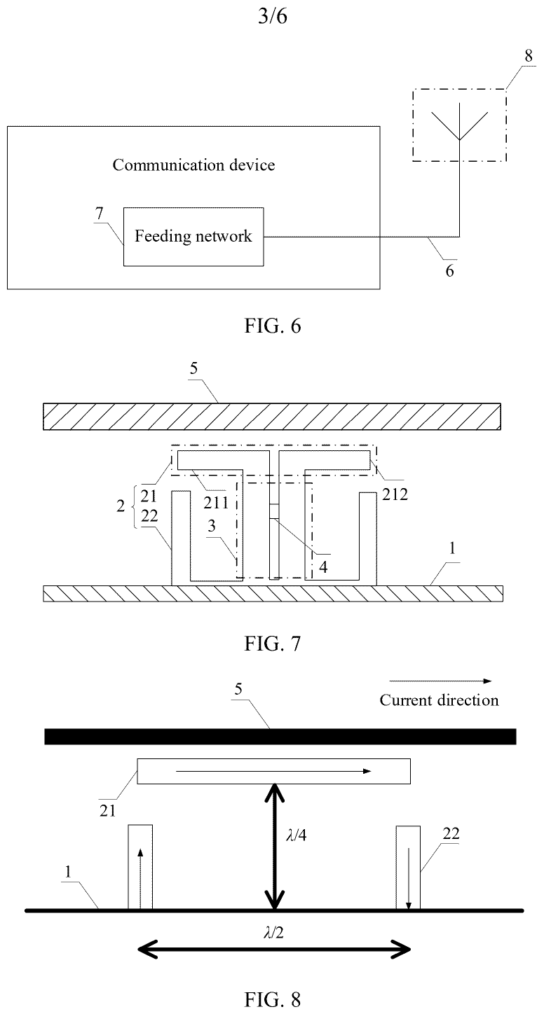

As shown in FIG. 6, an embodiment of this application provides a communication device, including a feeder 6, a feeding network 7, and the foregoing antenna 8. The feeding network 7 is connected to a feed point 4 of the antenna 8 through the feeder 6. The feeding network 7 receives and transmits an electromagnetic wave via the antenna 8. The communication device may be an AP device.

For example, as shown in FIG. 7, the antenna 8 in the communication device includes a ground plane 1 and at least one group of antenna elements 2.

The ground plane 1 is a large-area metal plane plate, and is used as a reference ground with zero electric potentials.

The antenna element 2 is disposed on the ground plane 1. One group of antenna elements 2 includes two dipole radiation arms 21 and two monopole radiation arms 22. The feed point 4 configured to be connected to the feeder 6 is provided on the dipole radiation arms 21 and/or the monopole radiation arms 22. The dipole radiation arms 21 are provided with a support structure 3.

For a same group of antenna elements, both the two dipole radiation arms 21 are disposed in parallel to the ground plane 1 via the support structure 3; both the two monopole radiation arms 22 are vertically disposed on the ground plane 1; and both the two dipole radiation arms 21 are located between the two monopole radiation arms 22, and the two dipole radiation arms 21 and the two monopole radiation arms 22 are in a same plane.

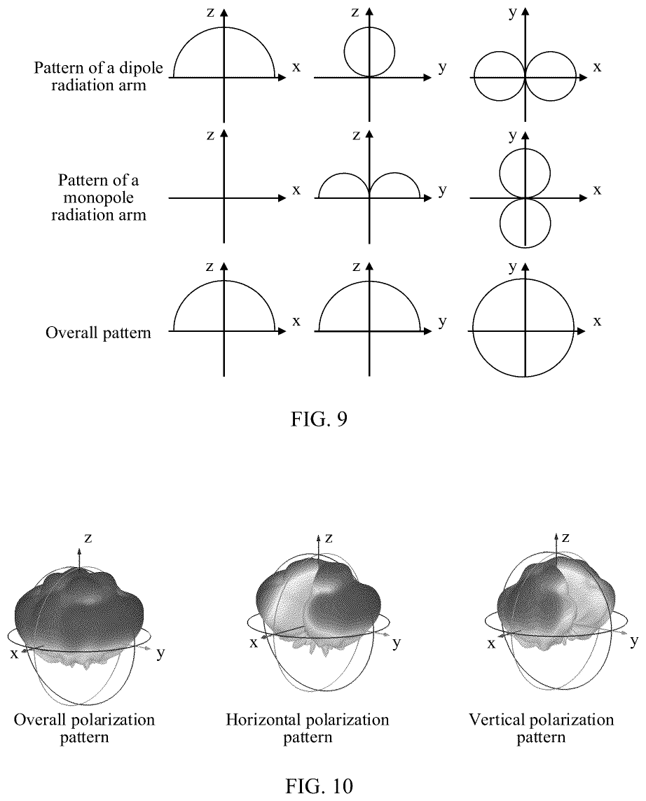

As shown in FIG. 8, when the antenna operates, current directions in the two dipole radiation arms 21 are the same, a phase difference between a current in the dipole radiation arm 21 and a current in the monopole radiation arm 22 is π/2, and current directions in the two monopole radiation arms 22 are opposite. FIG. 9 shows a pattern of the dipole radiation arm 21, a pattern of the monopole radiation arm 22, and a combined overall pattern of the dipole radiation arm 21 and the monopole radiation arm 22. It can be learned that the dipole radiation arm 21 and the monopole radiation arm 22 may respectively generate beams in two polarization directions, directions of the beams in the two polarization directions are perpendicular to each other, and the beams in the two polarization directions are combined into an omnidirectional beam.

A material of the antenna element 2 is not limited in this embodiment of this application. For example, the antenna element 2 is made of a metal mechanical part, a printed circuit board, or plastic with a metal coating.

A specific excitation manner of the antenna is not limited in this embodiment of this application. As shown in FIG. 7, in an implementation of the feed point 4, the two dipole radiation arms 21 are a first dipole radiation arm 211 and a second dipole radiation arm 212 respectively, and an end of the first dipole radiation arm 211 is coupled to an end of the second dipole radiation arm 212. The feed point 4 includes a first feed point 41, and the first feed point 41 is provided at a coupling point between the two dipole radiation arms 21. The dipole radiation arms 21 are directly excited through the first feed point 41, and the monopole radiation arms 22 are excited through coupling with the dipole radiation arms 21.

Optionally, to facilitate production and assembly of the antenna, for a same group of antenna elements 2, the support structure 3, the two dipole radiation arms 21, and the two monopole radiation arms 22 are integrally formed.

For example, the dipole radiation arms 21, the monopole radiation arms 22, and the support structure 3 are formed by integrally stamping a metal sheet, and a loss of pure metal is low. The support structure 3 is two parallel metal conductors. Ends of the two metal conductors away from the dipole radiation arms 21 are short-circuited and grounded (which is electrically connected to the ground plane 1). Coupling positions between the two monopole radiation arms 22 and the ground plane 1 are connected to the ends of the metal conductors away from the dipole radiation arms 21. The first feed point 41 is at the middle of the metal conductors. The monopole radiation arms 22 on two sides of the dipole radiation arms 21 are excited through coupling with the dipole radiation arms 21, so that resonance currents with opposite directions are generated on the two monopole radiation arms 22 respectively. In addition, types of dual-polarized omnidirectional antennas formed by stamping metal sheets are normalized, and one type of antenna meets a requirement of dual-polarized omnidirectional coverage. FIG. 10 is a beam pattern of the antenna. An overall pattern shows an omnidirectional beam, which is circular on a horizontal tangent plane, and a coverage angle on a pitch tangent plane is large. In a coordinate system shown in FIG. 10, directions of two polarization component beams of the antenna are perpendicular to each other.

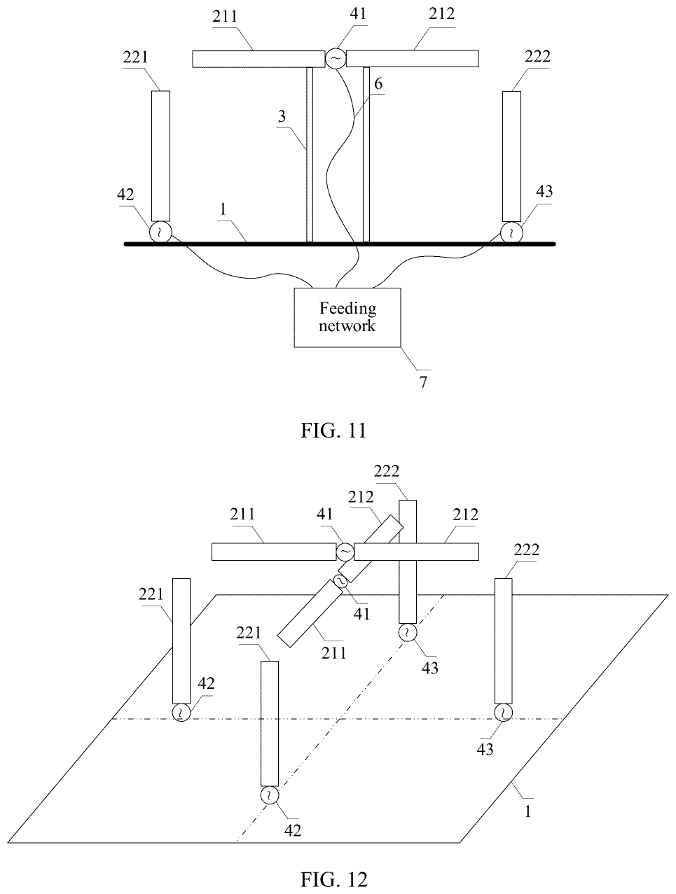

As shown in FIG. 11, in another implementation of the feed point 4, the two monopole radiation arms 22 are a first monopole radiation arm 221 and a second monopole radiation arm 222 respectively. The feed point 4 includes a second feed point 42 and a third feed point 43. The second feed point 42 is provided at a coupling point between the first monopole radiation arm 221 and the ground plane 1, and the third feed point 43 is provided at a coupling point between the second monopole radiation arm 222 and the ground plane 1. The first monopole radiation arm 221 is directly excited through the second feed point 42, the second monopole radiation arm 222 is directly excited through the third feed point 43, and the dipole radiation arms 21 are excited through coupling with the monopole radiation arms 22.

It should be understood that an exciting manner of the antenna may alternatively be selecting any part of the feed point 4 for direct feed exciting through the feeder 6. For example, the first feed point 41, the second feed point 42, and the third feed point 43 are all connected to the feeding network 7 through the feeder 6. The dipole radiation arms 21 are directly excited through the first feed point 41, the first monopole radiation arm 221 is directly excited through the second feed point 42, and the second monopole radiation arm 222 is directly excited through the third feed point 43, so that the antenna transmits an electromagnetic wave.

A length of the dipole radiation arm 21 is one eighth of a guided-wave wavelength to three eighths of the guided-wave wavelength, and the guided-wave wavelength is a wavelength of an electromagnetic wave received or transmitted by the antenna element 2 in an operating frequency band. When the length of the dipole radiation arm 21 may be flexibly adjusted between one eighth of the guided-wave wavelength and three eighths of the guided-wave wavelength based on an actual requirement, radiation effects are good. Optionally, the length of the dipole radiation arm 21 is one quarter of the guided-wave wavelength. In this case, the dipole radiation arm 21 can generate a resonance with the received or transmitted electromagnetic wave, so that the dipole radiation arm 21 converts the current into an electromagnetic wave or converts the received electromagnetic wave into a current with high efficiency.

A length of the monopole radiation arm 22 is one eighth of the guided-wave wavelength to three eighths of the guided-wave wavelength. When the length of the monopole radiation arm 22 may be flexibly adjusted between one eighth of the guided-wave wavelength and three eighths of the guided-wave wavelength based on an actual requirement, radiation effects are good. Optionally, the length of the monopole radiation arm 22 is one quarter of the guided-wave wavelength. In this case, the monopole radiation arm 22 can generate a resonance with the received or transmitted electromagnetic wave, so that the monopole radiation arm 22 converts the current into an electromagnetic wave or converts the received electromagnetic wave into a current with high efficiency.

Both distances between the two dipole radiation arms 21 and the ground plane 1 are one eighth of the guided-wave wavelength to three eighths of the guided-wave wavelength. Optionally, as shown in FIG. 8, both the distances between the two dipole radiation arms 21 and the ground plane 1 are one quarter of the guided-wave wavelength, where 2 is the guided-wave wavelength. A phase difference of 360°is generated by adding a round-trip phase difference of 180°that is generated when the distance is one quarter of the guided-wave wavelength and an additional phase difference of 180°that is generated when the electromagnetic wave is reflected by the ground plane 1. In this case, a reflected wave and an emergent wave at the dipole radiation arm 21 are just in phase, and electromagnetic wave superposition efficiency is the highest.

A distance between the two monopole radiation arms 22 is one quarter of the guided-wave wavelength to three quarters of the guided-wave wavelength. Optionally, as shown in FIG. 8, the distance between the two monopole radiation arms 22 is one quarter of the guided-wave wavelength. For a distance of a half of the guided-wave wavelength, a phase difference of 180°is generated. Because the current directions in the two monopole radiation arms 22 are opposite, a phase difference between excited electromagnetic waves is 180°. In this way, a phase difference of 360°is generated. In this case, the electromagnetic waves at the two monopole radiation arms 22 are just in phase, and electromagnetic wave superposition efficiency is the highest.

It should be understood that, when both the distances between the two dipole radiation arms 21 and the ground plane 1 are one quarter of the guided-wave wavelength, the distance between the two monopole radiation arms 22 is not limited to only a half of the guided-wave wavelength. Similarly, when the distance between the two monopole radiation arms 22 is a half of the guided-wave wavelength, the distances between the two dipole radiation arms 21 and the ground plane 1 are not limited to only one quarter of the guided-wave wavelength. The foregoing setting parameters are merely one of the implementations provided in this application.

In this embodiment of this application, a quantity of disposed antenna elements 2 is not limited, and may be one group of antenna elements disposed in the foregoing implementation, or may be another quantity, for example, two groups or four groups.

Optionally, as shown in FIG. 12, two groups of antenna elements 2 are disposed, planes in which the two groups of antenna elements 2 are located intersect, and the two groups of antenna elements 2 share the ground plane 1. In this implementation, the two groups of antenna elements 2 are disposed orthogonally. In other words, the planes in which the two groups of antenna elements 2 are located are perpendicular to each other. In another implementation, the planes in which the two groups of antenna elements 2 are located may alternatively intersect at another angle. Electromagnetic waves transmitted/received by the two groups of antenna elements 2 are superposed, to improve an antenna gain.

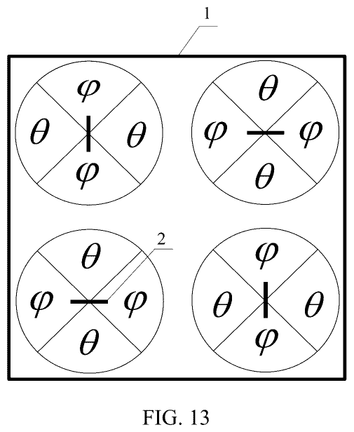

Optionally, as shown in FIG. 13, alternatively, four groups of antenna elements 2 may be disposed, the four groups of antenna elements 2 are disposed on the ground plane 1 in a manner of alternate rotation by 90°, and antenna elements 2 facing different directions generate horizontal polarization beams and vertical polarization beams in different quadrant areas. In this case, two horizontal beams and two vertical polarization beams can be received in any direction of the entire device.

In addition, when a plurality of groups of antenna elements 2 are disposed, a rotation angle of adjacent antenna elements 2 during disposition is not limited in this embodiment of this application. The antenna elements may be disposed in a manner of rotation by 90°, or may be disposed in a manner of rotation by 45°, or may be disposed in a manner of rotation by any other angle.

Further, the antenna includes a dielectric layer 5, where the dielectric layer 5 is disposed on a side of the antenna element 2 away from the ground plane 1. When there is the dielectric layer 5, the pattern of the dipole radiation arm 21 expands to two sides, so that roundness of a combined overall pattern is better, and the pattern has no null in a normal direction. In this implementation, the dielectric layer 5 is a radome.

In conclusion, according to the antenna and the communication device provided in embodiments of this application, the two dipole radiation arms 21 and the two monopole radiation arms 22 in the same group in the antenna are in the same plane, so that planarization of the antenna is implemented. In comparison with the conventional horizontal loop antenna, in this application, the space can be saved for arranging another component, so that the size of the dual-polarized omnidirectional antenna is reduced, and this helps miniaturize the dual-polarized omnidirectional antenna.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An antenna, comprising:
a ground plane and at least one group of antenna elements disposed on the ground plane, wherein one group of antenna elements of the at least one group of antenna elements comprises two dipole radiation arms and two monopole radiation arms, a feed point is provided on the two dipole radiation arms and/or the two monopole radiation arms, the two dipole radiation arms are provided with a support structure, and
for a same group of antenna elements;
the two dipole radiation arms are disposed in parallel to the ground plane via a support structure;
the two monopole radiation arms are vertically disposed on the ground plane; and
both the two dipole radiation arms are located between the two monopole radiation arms, and the two dipole radiation arms and the two monopole radiation arms are in a same plane.

2. The antenna according to claim 1, wherein a length of each dipole radiation arm is one eighth of a guided-wave wavelength to three eighths of the guided-wave wavelength, and the guided-wave wavelength is a wavelength of an electromagnetic wave received or transmitted by the antenna element in an operating frequency band.

3. The antenna according to claim 2, wherein the length of each dipole radiation arm is one quarter of the guided-wave wavelength.

4. The antenna according to claim 2, wherein a length of each monopole radiation arm is one eighth of the guided-wave wavelength to three eighths of the guided-wave wavelength.

5. The antenna according to claim 4, wherein the length of the monopole radiation arm is one quarter of the guided-wave wavelength.

6. The antenna according to claim 2, wherein distances between the two dipole radiation arms and the ground plane are one eighth of the guided-wave wavelength to three eighths of the guided-wave wavelength.

7. The antenna according to claim 6, wherein the distances between the two dipole radiation arms and the ground plane are one quarter of the guided-wave wavelength.

8. The antenna according to claim 2, wherein a distance between the two monopole radiation arms is one quarter of the guided-wave wavelength to three quarters of the guided-wave wavelength.

9. The antenna according to claim 8, wherein the distance between the two monopole radiation arms is a half of the guided-wave wavelength.

10. The antenna according to claim 1, wherein the feed point comprises:
a first feed point, provided at a coupling point between the two dipole radiation arms, wherein the two dipole radiation arms are directly excited through the first feed point.

11. The antenna according to claim 1, wherein the two monopole radiation arms include a first monopole radiation arm and a second monopole radiation arm, and the feed point comprises:
a second feed point, provided at a coupling point between the first monopole radiation arm and the ground plane; and
a third feed point, provided at a coupling point between the second monopole radiation arm and the ground plane, wherein
the first monopole radiation arm is directly excited through the second feed point, and the second monopole radiation arm is directly excited through the third feed point.

12. The antenna according to claim 1, wherein the antenna element is made of a metal mechanical part, a printed circuit board, or plastic with a metal coating.

13. The antenna according to claim 1, wherein for a same group of antenna elements, a support structure, the two dipole radiation arms, and the two monopole radiation arms are integrally formed.

14. The antenna according to claim 1, wherein two groups of antenna elements are disposed on the ground plane, planes in which the two groups of antenna elements are located intersect, and the two groups of antenna elements share the ground plane.

15. The antenna according to claim 1, further comprising a dielectric layer, wherein the dielectric layer is disposed on a side of the antenna element away from the ground plane.

16. A communication device, comprising a feeder, a feeding network, and an antenna, comprising: a ground plane and at least one group of antenna elements disposed on the ground plane, wherein one group of antenna elements of the at least one group of antenna elements comprises two dipole radiation arms and two monopole radiation arms, a feed point is provided on the two dipole radiation arms and/or the two monopole radiation arms, the two dipole radiation arms are provided with a support structure, and for a same group of antenna element;
the two dipole radiation arms are disposed in parallel to the ground plane via a support structure;
the two monopole radiation arms are vertically disposed on the ground plane; and
the two dipole radiation arms are located between the two monopole radiation arms, and the two dipole radiation arms and the two monopole radiation arms are in a same plane.

17. The communication device according to claim 16, wherein the feed point comprises:
a first feed point, provided at a coupling point between the two dipole radiation arms, wherein the two dipole radiation arms are directly excited through the first feed point.

18. The communication device according to claim 16, wherein the two monopole radiation arms include a first monopole radiation arm and a second monopole radiation arm, and the feed point comprises:
a second feed point, provided at a coupling point between the first monopole radiation arm and the ground plane; and
a third feed point, provided at a coupling point between the second monopole radiation arm and the ground plane, wherein
the first monopole radiation arm is directly excited through the second feed point, and the second monopole radiation arm is directly excited through the third feed point.

19. The communication device according to claim 16, wherein a length of the dipole radiation arm is one eighth of a guided-wave wavelength to three eighths of the guided-wave wavelength, and the guided-wave wavelength is a wavelength of an electromagnetic wave received or transmitted by the antenna element in an operating frequency band; or
wherein a length of the monopole radiation arm is one eighth of the guided-wave wavelength to three eighths of the guided-wave wavelength.

20. The communication device according to claim 19, wherein distances between the two dipole radiation arms and the ground plane are one eighth of the guided-wave wavelength to three eighths of the guided-wave wavelength.
